(19) United States
(12) Patent Application Publication
(10) Pub. No.: US 2004/0020944 A1
(43) Pub. Date: Feb. 5, 2004

(54) Dispenser and method for dispensing beverage containers

(76) Inventor: Raymond Johnson, Arlington Heights, IL (US)

Correspondence Address: Patrick G. Gattari, McDonnell Boehnen Hulbert & Berghoff, 32nd Floor, 300 S. Wacker Drive, Chicago, IL, 60606, US

(21) Appl. No.: 10/208,917

(22) Filed: Jul. 31, 2002

(51) Int. Cl. B67D 5/06

(52) U.S. Cl. 222/185.1

(57) ABSTRACT

A beverage container dispenser and a method for dispensing beverage containers from a carton are provided. The dispenser includes a support member with a front end, a back end, and a support surface positioned there between, the support surface being downwardly sloped towards the front end of the support member. The dispenser can further include protrusions at the front end and/or at one or both sides of the support member. A method for dispensing beverages is also provided, including the step of providing a dispenser having a support member with a front end, a back end, and a support surface positioned there between, the support surface being downwardly sloped towards the front end of the support member. The method further includes placing a carton of beverages on the support surface so the beverages roll towards the front end of the support member when beverages are removed from the carton.

### BACKGROUND

1. Field of the Invention

The present invention relates to beverage container dispensing, and more particularly to a beverage container dispenser and a method for dispensing beverage containers contained within a carton.

2. Description of Related Art

Users typically place cartons containing one or more beverage containers (i.e. cylindrical cans of soda pop, beer, juice, etc.) on a horizontal surface, such as a counter or a refrigerator shelf, for dispensing beverages to thirsty users. When the carton is full, a user can easily access beverage containers, as there are beverages located near the carton opening used to dispense the beverages. However, in many instances such cartons contain up to twelve or more beverage containers each. As a result, after users remove the beverages located near the carton opening, the remaining beverages become increasingly difficult to access, as they are located further from the opening. Dispensing the beverage containers furthest from the opening can require a user to reach far into the carton.

This problem is further exasperated by many Coca-Cola bottlers replacing the conventional 3×4 configured 12-packs with new, deeper 2×6 “Fridge Pack” 12-packs. Beverage cartons with a 2×6 configuration, such as the “Fridge Pack,” are designed to be more refrigerator friendly than the 4×6 cartons by fitting more easily into residential refrigerators. However, by making beverage cartons longer and more narrow, it becomes increasingly difficult to access beverages at the back of such cartons. Instead of having to reach a maximum of four cans deep into the carton, as in the 4×6 configuration, the new 2×6 configuration requires users to reach as far as six cans deep. For the 2×6 configured cartons this difficulty in dispensing beverages becomes problematic when the seventh can is removed from the carton, and there are not enough beverage containers remaining in the carton to push the remaining containers to the opening at the front of the carton.

Additionally, the slight backward sloping design of residential refrigerator shelves is an aggravating factor preventing users from easily accessing beverage containers contained within cartons. Residential refrigerator shelves, by design, are sloped slightly backward in order to prevent items from rolling off the shelves and out of the refrigerator. This backward sloping effect could cause the beverage containers in a carton to roll to and stay at the back of the carton, forcing the user to reach far into the carton to access such beverages. Further, a refrigerator placed on an uneven or backward sloping floor could exaggerate the backward sloping design of refrigerator shelves.

This difficulty of dispensing beverage containers not located near the carton opening forces users to spend additional time and exert additional effort to remove each of the remaining beverages from the carton. Such difficulty of dispensing beverages may cause wasted time for all users, possible pain, and excessive difficulty for elderly and/or physically handicapped persons. Accordingly, it would be advantageous for users to place cartons of beverage containers on dispensers that cause the beverage containers not located near the carton opening to roll towards the opening upon removal of the beverages closest to the carton opening. As a result, the beverages are more easily dispensed.

Accordingly, it would be desirable to have a beverage container dispenser that allows users to more quickly and easily access beverage containers remaining in a carton after the containers located in close proximity to the carton opening have been removed. Such a dispenser would enable all users to more quickly and easily access such beverages, and allow elderly and physically handicapped persons to access such beverages without undue burden or difficulty.

### SUMMARY OF THE INVENTION

In one aspect, an exemplary embodiment provides a beverage container dispenser support member. The support member has a front end, a back end, and a support surface positioned there between. The support surface is downwardly sloped towards the front end of the support member. Additionally, the support surface is adapted to support a carton having one or more beverage containers, and to urge the beverage containers towards the front end of the support member, thereby facilitating the dispensing of beverage containers.

In a second aspect, an exemplary embodiment provides a beverage container dispenser. The dispenser has a support member with a front end, a back end, and a support surface positioned there between. The support surface is downwardly sloped towards the front end of the support member. Additionally, the dispenser has a carton containing one or more beverage containers. The carton has an opening for dispensing the beverage containers. Further, the carton is positioned on the support surface such that the opening is positioned at the front end of the support member.

In a third aspect, an exemplary embodiment provides a method for dispensing beverages. The beverage containers are dispensed by providing a support member that has a front end, a back end, and a support surface positioned there between. The support surface is downwardly sloped towards the front end of the support member. Additionally, a carton, containing one or more beverage containers and an opening for dispensing the beverage containers is positioned on the support surface in a manner that allows the beverage containers to roll towards the front end of the support member when one of the beverage containers is removed from the carton.

These as well as other aspects and advantages of the present invention will become apparent to those of ordinary skill in the art by reading the following detailed description, with appropriate reference to the accompanying figures.

### BRIEF DESCRIPTION OF THE FIGURES

An exemplary embodiment of the present invention is described herein with reference to the figures, in which:

FIG. 1 is a perspective view of an exemplary embodiment of a beverage container dispenser of the present invention; and

FIG. 2 is a perspective view of an alternative embodiment of the beverage container dispenser.

### DETAILED DESCRIPTION

Cartons containing beverage containers do not provide for easy dispensing of beverages after the containers positioned closest to the carton opening, used to dispense beverages, have been removed. When a user removes such containers, the remaining containers stay at the back of the carton and become increasingly more difficult to dispense. Thus, an improved beverage dispenser is needed.

The present invention is directed to an improvement over the current manner in which beverages are dispensed from cartons by providing a beverage container dispenser to dispense such beverage containers. Such containers are typically 12-ounce, cylindrical cans of soda pop, beer, juice, etc. However, it should be understood that the containers can include all types of cylindrical and/or rollable beverage containers. In particular, according to an exemplary embodiment of the invention, a downwardly sloped support surface of a support member will urge the beverage containers towards the carton opening.

As a particular example, a user might place a beverage carton containing beverage containers, stacked in a two high and six deep configuration, on a support surface of the beverage container dispenser. Doing so would allow the beverage containers remaining in the carton, after a user removes at least one container, to roll towards the carton opening and be dispensed more easily.

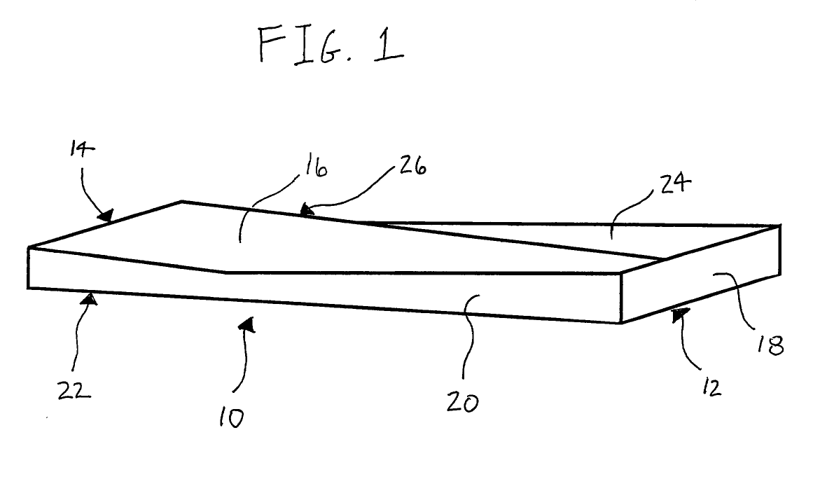

Referring to the figures, FIG. 1 shows an exemplary embodiment of a beverage container dispenser support member 10 for improving the ease with which beverage containers may be dispensed from a carton. The dispenser 10 may have a front end 12, a back end 14 opposite the front end 12, and a support surface 16 positioned there between. The support surface 16 is downwardly sloped towards the front end 12 of the support member 10. It is preferred that the angle of the support surface 16 may be between about five degrees and about twenty degrees. However, any angle that allows the containers to roll towards the front of the carton, without causing the containers to roll out of the carton, is within the scope of the invention. In operation, the support surface 16 will support a carton containing one or more beverage containers, while the downward slope will force the beverage containers remaining after removal of one or more beverages towards the carton opening.

Additionally, the support member 10 may have a protrusion 18 at the front end 12. This protrusion 18 can prevent beverage containers from being forced from the carton, and can prevent the carton from sliding forward, and possibly off the dispenser 10. The protrusion 18 can take many forms, including, but not limited to, a wall perpendicular to the support surface 16, as shown, or a rib. The uses of the protrusion described herein are illustrative only, and do not limit such uses.

Further, a protrusion 20 can be connected to the support member 10 at one side 22 of the support member 10, and/or a protrusion 24 can be connected at the other side 26. Such protrusions could aid in better securing the carton to the dispenser 10. The protrusions connected to the sides of the support member 10 could take on many forms, including, but not limited to, a vertical sidewall that extends from the front end 12 of the support member 10 to a point between the front end 12 and the back end 14. In addition, when there are protrusions on both sides of the support member 10, the protrusions need not be identical (e.g., the protrusion on one side could be a vertical sidewall, and the protrusion on the other side could be a rib). It should be understood that the uses of the protrusions described herein are illustrative only and do not limit such uses.

The protrusion(s) at both the front end and the sides may be connected to the support member 10 using any number of known methods, including, but not limited to, adhesive attachment, mechanical interference attachment, and injection molding of the support member 10 and the protrusion(s) as a single piece. In addition, although not shown, it should be understood that the protrusion(s) might be detachable from the support member 10 for compact storage and packaging purposes. However, it should also be understood that the protrusion(s) and the support member 10 might be formed as an integral one-piece unit.

The support surface 16 may be made of any number of desirable materials. Preferably, however, the support surface 16 will be made from, or coated with, a non-slip material such as rubber.

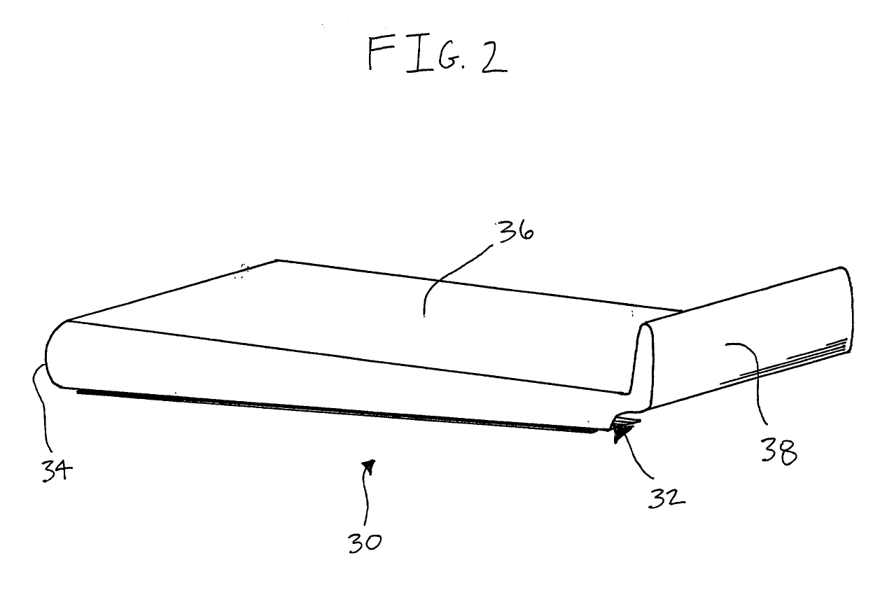

FIG. 2 shows an alternative embodiment of a beverage container dispenser support member 30. The shown dispenser 30 is similar to the dispenser in FIG. 1, with only a few exceptions. The dispenser 30 may have a front end 32, a back end 34 opposite the front end 32, and a support surface 36 positioned there between. The support surface 36 is downwardly sloped towards the front end 32 of the support member 30. It is preferred that the angle of the support surface 36 may be between about five degrees and about twenty degrees. However, any angle that allows the containers to roll towards the front of the carton, without causing the containers to roll out of the carton, is within the scope of the invention. In operation, the support surface 36 will support a carton containing one or more beverage containers, while the downward slope will force the beverage containers remaining after removal of one or more beverages towards the carton opening.

The dispenser 30 has an L-shaped protrusion 38 connected to the support member 30 at the front end 32. The L-shaped protrusion 38 is connected to the support member 30 in such a way as to create a wall perpendicular to the support surface 36. This protrusion 38 can prevent the sloped support surface 36 from forcing the beverage containers from the carton, and can prevent the carton from sliding forward and possibly off the dispenser 30.

The L-shaped protrusion 38 may be connected to the support member 30 using any number of known methods, including, but not limited to, adhesive attachment, mechanical interference attachment, and injection molding of the support member 30 and the protrusion 38 as a single piece. In addition, although not shown, it should be understood that the protrusion 38 might be detachable from the support member 30 for compact storage and packaging purposes. However, it should also be understood that the protrusion 38 and the support member 30 might be formed as an integral one-piece unit.

The beverage container dispenser support member may be used in the following manner. A user may place a carton containing one or more beverage containers, either before of after the user opens the carton, on the support surface of the dispenser. The carton should be oriented such the carton opening is positioned at the front end of the dispenser, thereby allowing beverage containers remaining in the carton after removal of one or more containers to roll towards the carton opening and fill the vacancy left by the removed beverage container(s). This can continue until the carton is empty. Forcing the beverage containers to replace the vacancy left by previously removed containers, in this manner, dispenses the remaining beverage containers more easily. In the absence of the beverage dispenser, the user might have to reach further into the carton through the carton opening to access the remaining beverage containers.

Additionally, a base may be connected to the support member. The base can be connected to the support member using any number or known methods, including, but not limited to adhesive attachment, mechanical interference attachment, and forming the support member and base as a one integral unit. In addition, although not shown, it should be understood that the base may be detached from the support member for compact packaging and storage purposes. However, it should also be understood that the base and the support member may be formed as an integral one-piece unit.

The beverage dispenser may be further configured to fit on the shelf of a residential refrigerator. Such a configuration would allow a user to keep the beverages cold in anticipation of the beverages being dispensed. Many refrigerators have wire-rack type shelves. Therefore, the bottom of the dispenser should have a flat or a grating type surface to ensure that the dispenser remains flat on the wire shelf.

An exemplary embodiment of the present invention has been described above. Those skilled in the art will understand, however, that changes and modifications may be made to this embodiment without departing from the true scope and spirit of the present invention, which is defined by the claims.

I claim:

1. A beverage container dispenser support member comprising:
a front end and a back end with a support surface positioned there between, the support surface being downwardly sloped towards the front end of the support member; and
the support surface is adapted to support a carton having one or more beverage containers and to urge the beverage containers towards the front end of the support member to facilitate the dispensing of the beverage containers.

2. The dispenser of claim 1 wherein the support surface is downwardly sloped at an angle such that the beverage containers are forced towards the front end of the support member.

3. The dispenser of claim 2 wherein the angle is between about five degrees and about twenty degrees.

4. The dispenser of claim 1 wherein the support surface is made from a non-slip material.

5. The dispenser of claim 1 wherein the support member fits on a surface inside a refrigerator.

6. The dispenser of claim 1 wherein the support member has a protrusion at the front end for preventing beverage containers from being forced from the carton.

7. The dispenser of claim 1 wherein the support member has a protrusion at one side for securing a carton to the dispenser.

8. The dispenser of claim 1 wherein the support member has a protrusion at the both sides for securing a carton to the dispenser.

9. A beverage container dispenser comprising:
a support member having a front end and a back end with a support surface positioned there between, the support surface being downwardly sloped towards the front end of the support member; and
a carton containing one or more beverage containers and having an opening for dispensing the beverage containers;
wherein the carton is positioned on the support surface such that the opening is positioned at the front end of the support member.

10. The dispenser of claim 9 wherein the support surface is downwardly sloped at an angle of between about five degrees and about twenty degrees.

11. The dispenser of claim 9 wherein the support surface is made from a non-slip material.

12. The dispenser of claim 9 wherein the support member is connected to a base.

13. The dispenser of claim 9 wherein the support member and the carton fit on a surface inside a refrigerator.

14. The dispenser of claim 9 wherein the support member has a protrusion on the front end.

15. The dispenser of claim 14 wherein the protrusion is a wall perpendicular to the support surface.

16. The dispenser of claim 9 wherein the support member has a protrusion on one side.

17. The dispenser of claim 9 wherein the support member has a protrusion at both sides.

18. A method for dispensing beverages comprising the steps of:
providing a beverage dispenser having a support member, the support member having a front end and a back end with a support surface positioned there between, the support surface being downwardly sloped towards the front end of the support member; and
placing a carton, containing one or more beverage containers and an opening for dispensing the beverage containers, on the support surface in a manner that allows the beverage containers to roll towards the front end of the support member when one of the beverage containers is removed from the carton.

19. The method of claim 18 further comprising the step of making the angle of the downwardly sloped support surface between about five and about twenty degrees.

20. The method of claim 18 further comprising the step of making the support surface from a non-slip material.

21. The method of claim 18 further comprising the step of connecting the support member to a base.

22. The method of claim 18 further comprising the step of connecting a protrusion to the support member at the front end.

23. The method of claim 22 further comprising the step of making the protrusion a wall perpendicular to the support surface.

24. The method of claim 18 further comprising the step of connecting a protrusion to the support member at one side.

25. The method of claim 18 further comprising the step of connecting a protrusion to the support member at both sides.
